(19) United States
(12) Patent Application Publication
(10) Pub. No.: US 2005/0232259 A1
(43) Pub. Date: Oct. 20, 2005

(54) Method and apparatus for data routing

(76) Inventors: Inching Chen, Portland, OR (US); Walter L. Snyder, San Jose, CA (US); Ernest Tsui, Cupertino, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/828,134

(22) Filed: Apr. 19, 2004

(51) Int. Cl. H04L 12/56

(52) U.S. Cl. 370/386

(57) ABSTRACT

A method and apparatus for data routing is generally described. In accordance with one example embodiment of the invention, a method to read at least a portion of a data packet, the at least portion of a data packet including content to configure at least one dedicated route through at least one node of a plurality of interconnected nodes communicatively coupled by one or more communication links and selectively configuring the at least one dedicated route based, at least in part, on the content, to route data from a source to a destination.

### TECHNICAL FIELD

Embodiments of the present invention generally relate to the field of electronic systems, and more particularly, to a method and apparatus for data routing.

### BRIEF DESCRIPTION OF THE DRAWINGS

The present invention is illustrated by way of example, and not by way of limitation, in the figures of the accompanying drawings in which like reference numerals refer to similar elements and in which:

FIG. 1 is a block diagram of an example electronic system incorporating the teachings of the present invention, according to one embodiment of the invention;

FIG. 2 is an architectural diagram of an example multi-node device, according to one embodiment of the present invention;

FIG. 3 is a graphical illustration of an example memory register, according to one embodiment of the present invention;

FIG. 4 is an illustration of an example data packet, according to one embodiment of the present invention; and

FIG. 5 is a flow chart of an example method to configure a route or route data in accordance with the teachings of the present invention, according to one embodiment.

### DETAILED DESCRIPTION

Embodiments of the present invention are generally directed to a method and apparatus for data routing. In accordance with one example embodiment, a router is introduced herein. As described more fully below, the innovative router is operable to read at least a portion of a data packet including content to indicate the configuration of a dedicated route through at least one node of a plurality of interconnected nodes coupled by one or more communication links and selectively configure the dedicated route based on the content, to route data from a source to a destination.

In the following description, for purposes of explanation, numerous specific details are set forth in order to provide a thorough understanding of the invention. It will be apparent, however, to one skilled in the art, that the invention can be practiced without these specific details. In other instances, structures and devices are shown in block diagram form in order to avoid obscuring the invention.

Reference in the specification to “one embodiment” or “an embodiment” means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment. Likewise, the appearances of the phrase “in another embodiment,” or “in an alternate embodiment” appearing in various places throughout the specification are not all necessarily referring to the same embodiment.

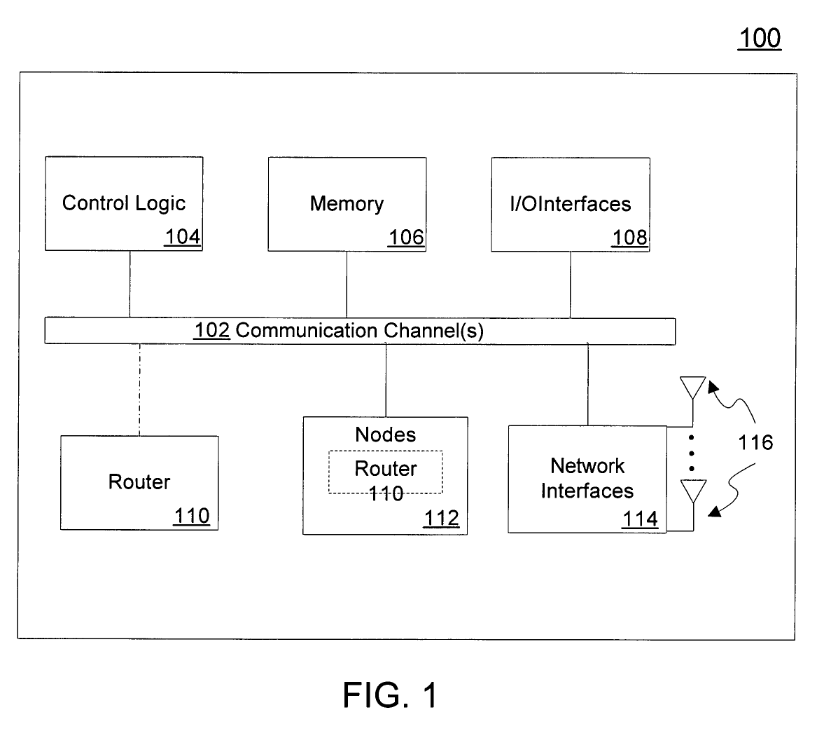

FIG. 1 is a block diagram of an example electronic system incorporating the teachings of the present invention, according to one embodiment of the invention. Electronic system 100 may be, for example, a multi-node computer system, a multi-core system on a chip device, a multi-node device, or any other multi-node and/or multi-core electronic system.

In accordance with the illustrated example embodiment of FIG. 1, electronic system 100 is depicted comprising communication channel(s) 102, control logic 104, memory 106, input/output (I/O) interfaces 108, router 110, nodes 112, network interfaces 114 and antennae 116, each coupled as depicted.

In accordance with one example embodiment of the present invention, control logic 104 may control the overall operation of electronic system 100 and is intended to represent any of a wide variety of logic device(s) and/or executable content to implement the operation of electronic system 100, described herein. In this regard, control logic 104 may well be comprised of a microprocessor, network processor, microcontroller, field programmable gate array (FPGA), application specific integrated circuit (ASIC), executable content to implement such control features and/or any combination thereof.

Electronic system 100 further includes memory 106 to store information/features offered by electronic system 100. In this regard, memory 106 may also be used to store temporary variables or other intermediate information during execution of instructions by control logic 104. As used herein, memory 106 may well include a wide variety of memory media including but not limited to volatile memory, non-volatile memory, flash, programmable variables or states, random access memory (RAM), read-only memory (ROM), or other static or dynamic storage media.

In accordance with one example embodiment, machine-readable instructions can be provided to memory 106 from a form of machine-accessible medium. As used herein, a machine-accessible medium is intended to represent any mechanism that provides (i.e., stores and/or transmits) information in a form readable by a machine (e.g., electronic system 100). For example, a machine-accessible medium may well include ROM; RAM; magnetic disk storage media; optical storage media; flash memory devices; electrical, optical, acoustical or other form of propagated signals (e.g., carrier waves, infrared signals, digital signals); and the like. Instructions may also be provided to memory 106 via a remote connection through I/O interfaces 108 or network interfaces 114.

Router 110 represents an element of electronic system 100 that may route data from a source to a destination. As used herein, router 110 is intended to represent any of a number of hardware and/or software elements to route data through electronic system 100. In this regard, according to one example implementation, router 110 may well comprise one or more of a microprocessor, software application, a hardware device driver, a microprocessor, an I/O micro engine, embedded logic and the like.

As used herein, nodes 112 represent elements of electronic system 100 that may be source, intermediate or destination nodes for data routed through electronic system 100. In this regard, according to one example embodiment, nodes 112 may well comprise, one or more of a switch fabric, network processor, microprocessor, processing elements (PE), embedded logic, or the like.

According to one example embodiment, nodes 112 may comprise a router 110. Alternatively, router 110 may well reside outside of nodes 112 and may be coupled to nodes 112 through, e.g. communication channel(s) 102, I/O interfaces 108 or network interfaces 114.

As used herein, I/O interfaces 108 may also enable one or more element(s), e.g., control logic 102, to interact with input and/or output devices. For example, input devices such as a mouse, keyboard, touchpad, etc. and/or output devices (e.g., cathode ray tube monitor, liquid crystal display, etc.).

As used herein, network interfaces 114 represent elements of electronic system 100 that may enable digital and/or analog communications with systems or elements located remote to electronic system 100. In this regard, network interfaces 114, utilizing communication protocols such as ethernet, synchronous optical network (SONET), asynchronous transfer mode (ATM) or the like, are able to communicate with remote electronic systems over wired local area networks (LANs), metropolitan area networks (MANs), wide area networks (WANs) or the like, although the invention is not limited in this regard. Alternatively, network interface 114 utilizing such wireless communication protocols such as Wi-Fi (802.11) and WiMAX (802.16) or the like, are able to communicate with remote electronic systems over wireless LANs, MANs, WANs and/or cellular networks or the like, although the invention is not limited in this regard.

As used herein, antennae 116 represent communication elements of electronic system 100 that may allow wireless communications with electronic system 100 through network interfaces 114. In this regard, antennae 116 may be coupled with transceivers to provide a wireless communication link with systems remote to electronic system 100.

In an example embodiment, antennae 116 may comprise one or more omni directional and/or directional microwave, radio frequency (RF), infrared (IR) antennae or the like

It should be appreciated that router 110 need not be integrated within electronic system 100 for electronic system 100 to access and benefit from the features of router 110 described herein. That is, network interfaces 114 and/or I/O interface(s) 108 may provide a communications interface and an electronic system through, e.g., a communication element such as antennae 116, thus, may access and employ the features of router 110.

Network interfaces 114 and/or I/O interfaces 108 may provide a communications interface to allow a source to route data to electronic system 100 or through electronic system 100 using router 110. As mentioned previously, router 110 may contain any number of hardware and/or software elements(s) to route data through electronic system 100. For example, router 110 may include a plurality of input ports and output ports linked by a crossbar switch or other types of switching fabric, although the invention is not limited in this regard.

In the context of at least one embodiment, data may be transmitted from a source to a destination through at least one node of a plurality of interconnected nodes 112. In an example embodiment, nodes 112 may be interconnected by one or more communication links, e.g., point-to-point communication links in a mesh topology, although the invention is not limited in this regard. Interconnection by one or more communication links between nodes 112 may enable one or more nodes 112 to exchange data with one another and/or with other devices communicatively coupled to interconnected nodes 112.

In an example embodiment, data may be exchanged in the form of discrete segments of data, also referred to as “data packets.” Additionally, data packets may be exchanged by use of one or more methods of data transfer, although the invention is not limited in this regard. Two examples of data exchange include packet switching and circuit switching. Packet switching may also be referred to as arbitrated routing, while circuit switching may be referred to as dedicated routing, although the invention is not limited in this regard.

In an example embodiment, arbitrated routing is a method of routing data that utilizes a store and forward approach, wherein at least a portion of a data packet may be routed by router 110 through nodes 112 based, at least in part, on what route or routes through nodes 112 are available. If a different source is also requesting use of the same route, the resources of the route are arbitrated between the different sources requesting use of the route. In an example embodiment, to prevent data loss, at least of portion of a data packet from a source may be temporarily stored while this arbitration occurs and the at least a portion of a data packet forwarded once a route becomes available. Arbitrated routing may however, result in unpredictable latencies.

In an example embodiment, dedicated routing is a method of routing data wherein a dedicated or substantially dedicated route through nodes 112 is configured for the routing of data from a source to a destination. When configured, resources to establish a dedicated or substantially dedicated route through one or more nodes 112 are allocated and data from the source to the destination is then routed through the dedicated or substantially dedicated route. This may eliminate or reduce unpredictable latencies as data is routed through a dedicated or substantially dedicated route where latencies are easily determined, although the invention is not limited in this regard.

A determination of whether to route the data through an arbitrated or dedicated route may be determined by router 110 dynamically at the time data is received by an interconnected node, statically at start-up or a combination of both.

According to one example embodiment, router 110 configuring a route and/or routing data through the route, may well be implemented in hardware, software, firmware, or any combination thereof e.g., coupled to system 100, as shown. In this regard, router 110 may well be implemented as one or more of an ASIC, a special function controller or processor, an FPGA, or other hardware device, firmware or software to perform at least the functions described herein.

Although shown as a number of disparate functional elements, those skilled in the art will appreciate from the disclosure herein, that routers of greater or lesser complexity that nonetheless perform the functions/features described herein, whether implemented in hardware, software, firmware or a combination thereof, are anticipated within the scope and spirit of the present invention.

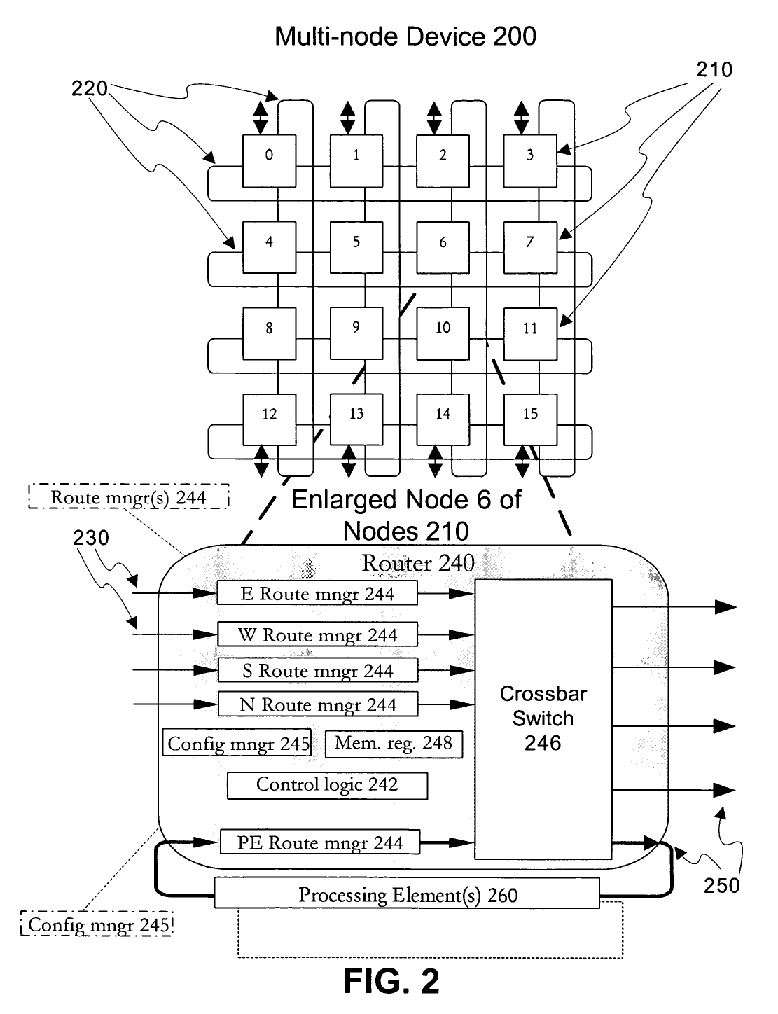

FIG. 2 is an architectural diagram of an example multi-node device, according to one embodiment of the present invention. In accordance with the illustrated example embodiment of FIG. 2, multi-node device 200 is depicted comprising of a plurality of nodes 210 and communication links 220 each coupled as depicted.

In accordance with one example embodiment, multi-node device 200 is depicted comprising of a plurality of nodes 210 that are interconnected in a mesh of nodes 0-15, including wrap-around interconnects, although the invention is not limited in this regard. In an example implementation, multi-node device 200 may be a network processor and at least a portion of nodes 0-15 may be processing nodes interconnected by communication links 220.

In an example embodiment, communication links 220 may be either bi-directional communication links or consist of two unidirectional communication links. In this regard, communication links 220 may act as an output and an input for nodes 0-15, although the invention is not limited in this regard.

In accordance with an example embodiment, one or more nodes 210 may receive and/or is transmit data from/to a host device or electronic system through one or more nodes 210 tasked with the function to interface with the electronic system such as I/O interfaces 108. Additionally, one or more nodes 210 may receive and/or transmit data from/to elements remote to multi-node device 200 through network interfaces 114 and/or I/O interfaces 108, i.e. one or more nodes 210 may function as an analog front end for wireless communications, although the invention is not limited in this regard.

In an example embodiment, an enlarged view of node 6 of nodes 210 is depicted comprising one or more of a router 240 and processing element(s) 260 each coupled as depicted.

In accordance with one example embodiment of the present invention, router 240 is depicted comprising one or more of an input ports 230, control logic 242, route manager(s) 244, configuration manager 245, crossbar switch 246, memory register 248 and output ports 250. As developed more fully below, configuration manager 245 and route manager(s) 244 of router 240 selectively configure a dedicated route and/or route data through router 240. Also, as explained above, and developed more fully below, the data is routed through router 240 based, at least in part, on at least a portion of a data packet's content read by configuration manager 245 and/or route manager(s) 244.

As used herein, control logic 242 may control the overall operation of router 240 and is intended to represent any of a wide variety of logic device(s) and/or executable content to implement the operation of router 240, described herein. In this regard, control logic 242 may well be comprised of a microprocessor, microcontroller, FPGA, ASIC, executable content to implement such control features and/or any combination thereof. In alternate embodiments, the features and functionality of control logic 242 may well be implemented outside router 240.

As used herein, memory register 248 is intended to represent a wide variety of memory media including, but not limited to, volatile memory, non-volatile memory, programmatic variables or states, flash, RAM and ROM or the like. In an example embodiment, memory register 248 may store route information for at least one dedicated route configured by configuration manager 245 through router 240. In alternate embodiments, the features and functionality of memory register 248 may will be implemented outside router 240.

In accordance with one example embodiment, processing element(s) 260 is depicted. As used herein, processing element(s) 260 is an element of node 6 that may perform various processing functions or tasks on data routed to/from node 6. In this regard, as explained in more detail below, processing element(s) 260 is coupled to router 240 through at least one communication link and thus may be a source and/or destination for data routed through multi-node device 200.

According to one example embodiment, control logic 242 may selectively invoke an instance of configuration manager 245 to read the contents of a data packet received by node 6, the data packet including content to indicate the configuration of a dedicated route and/or route data through router 240 to route data from a source to a destination. Source(s) and/or destination(s) may reside within multi-node device 200 and/or may be remote to multi-node device 200.

According to one example embodiment, configuration manager 245 may be coupled to router 240 within router 240. Alternatively, configuration manager 245 may well reside outside of router 240 and couple to router 240 through, for example, communication links 220.

As used herein, input ports 230 provide at least one route into router 240 of node 6. In an example implementation, nodes 0-15 are respectively configured to communicate with each of their respective four nearest neighbors, which are the four communicatively coupled neighbors for each node with communication links 220. For example, as shown on multi-node device 200, node 6 would be coupled by communication links 220 to nodes 2, 5, 7 and 10, and, in this illustration, node 2 would be the north nearest neighbor, node 10 would be the south nearest neighbor, node 5 would be the west nearest neighbor, and node 7 would be the east nearest neighbor. In addition, input ports 230 are also selectively coupled to a fifth communication link coupled to processing element(s) 260.

In an example embodiment, at least one route manager(s) 244 is assigned to each of the five input ports 230 of node 6. For example, at least one route manager(s) 244 may be assigned to the input port corresponding to node 2, which is the north nearest neighbor of node 6.

As used herein, crossbar switch 246 is depicted as being selectively coupled to input ports 230 and output ports 250. As explained above, in accordance with one example embodiment, each output ports 250 correspond to the four nearest neighbor nodes 2, 5, 7, and 10 and processing element(s) 260. As introduced above and developed in more detail below, memory register 248 may store the output port addresses corresponding to each of the five output ports 250 selectively coupled to crossbar switch 246.

According to one example embodiment, route manager(s) 244 may be coupled to router 240 within router 240. Alternatively, route manager(s) 244 may well reside outside of router 240 and couple to router 240 through, for example, communication links 220.

According to one example embodiment, content in the form of at least a portion of a data packet is received by node 6 of multi-node device 200. The content may indicate the configuration of a route through node 6 for data from a source within multi-node device 200 to a destination within multi-node device 200. Configuration manager 245 of node 6 upon reading this content may selectively configure at least one dedicated route through router 240 based, at least in part, on the content. As explained in more detail below, the dedicated route through router 240 is then stored by configuration manager 245 in memory register 248.

Further, when data from the source to the destination, in the form of a data packet, is received by node 6, at least a portion of the data packet may include content that may indicate to route manager(s) 244 to route the data over a previously configured dedicated route. Based, at least in part, on this content, route manager(s) 244 may route data through router 240 using the route information stored in memory register 248 to select the proper output port that may correspond to the configured dedicated route.

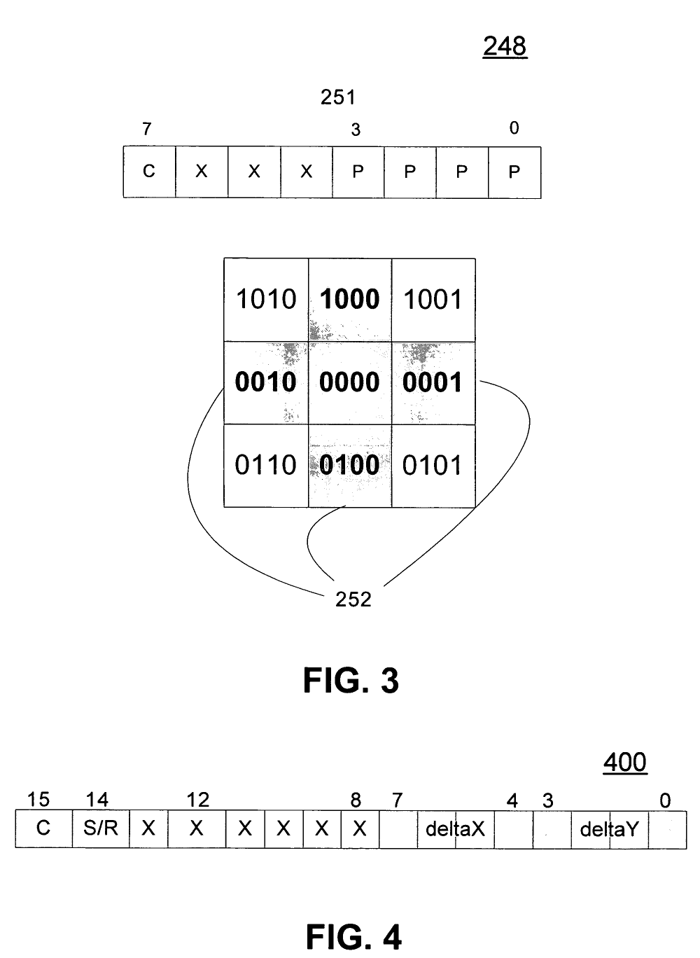

FIG. 3 is a graphical illustration of an example memory register, according to one embodiment of the present invention. In accordance with the graphical illustration of FIG. 3, memory register 248 is depicted comprising of an 8-bit table entry 251 with a 4-bit output port address 252.

In accordance with one example embodiment of the present invention, memory register 248 may store route information for at least one configured route (i.e. by configuration manager 245) through a router (i.e. router 240) in the form of table entry 251. Bit 7 of table entry 251 identifies whether the route is for a configured dedicated route. Bits 0-3 identify the output port address for the route, although the invention is not limited in this regard.

In accordance with an example embodiment of the present invention, each output port address may correspond to one of the 4-bit output port address 252 depicted in FIG. 3. As explained above, each output port may correspond to the four nearest neighbor nodes and processing element(s) 260. For example, a 4-bit value of 1000 for output port address 252 represents the north nearest neighbor, node 2, whereas a 4-bit value of 0001 represents the east nearest neighbor, node 7, and a 4-bit value of 0000 represents processing element(s) 260, although the invention is not limited in this regard.

In an example implementation, configuration manager 245 may configure a dedicated route through router 240 to route data from a source to a destination. Configuration manager 245 may configure the dedicated route through router 240 to route data to the north nearest neighbor, node 2. In this example, the output port address corresponding to this route has a 4-bit value of 1000. Configuration manager 245 may then populate bits 0-3 of table entry 251 with the 4-bit value of 1000 and also populate bit 7 to indicate a configured dedicated route to output port address 1000. In this regard, as long as the dedicated route remains configured, route manager(s) 244 may access register 248 and read table entry 251 to determine the output address for data to through the configured dedicated route of router 240.

FIG. 4 is an illustration of an example data packet, according to one embodiment of the present invention. In accordance with the illustrated example embodiment of FIG. 4, a pilot data packet 400 is depicted comprising of 16-bits of data, although the invention is not limited in this regard.

In an example embodiment, a pilot data packet 400 is generated by at least one source from either the mesh of interconnected nodes of multi-node device 200 or a source from outside of the mesh of interconnected nodes of multi-node device 200. As explained in more detail below, the pilot data packet 400 contains content to indicate the type of packet and the destination for data.

In an example embodiment, a pilot data packet 400 may be associated with data from a source to a destination that is to be routed through/to the plurality of interconnected nodes of multi-node device 200, although the invention is not limited in this regard.

In accordance with an example embodiment, bit 15 of pilot data packet 400 identifies whether pilot data packet 400 is indicating the configuration of at least one dedicated route to route data through a router. Bit 14 identifies the type of configuration as either a release or setup of a dedicated route through a router. Bits 0-7 may be utilized by configuration manager 245 as an address offset that may indicate whether an interconnected node is the destination for data and may also indicate where to route the data if the interconnected node is not the destination.

In an example embodiment, the address offset for deltaX for an interconnected node 210 of multi-module device 200 is decremented by one if coming from the west nearest neighbor or incremented by one if coming from the east nearest neighbor, although the invention is not limited in this regard. The address offset for deltaY is decremented by one if coming from the north nearest neighbor or incremented by one if coming from the south nearest neighbor, although the invention is not limited in this regard.

In an example embodiment, a node may determine whether it is the destination for data from a source by, after updating the offset, reading the offset and if both deltaX and deltaY are equal to zero, the node is the destination for data from the source. For example, if after updating the offset, deltaX is 0000 and deltaY is 0000 then the node is the destination, although the invention is not limited in this regard. Accordingly, if deltaX is 0000 and deltaY is 0001 then the node is not the destination, although the invention is not limited in this regard.

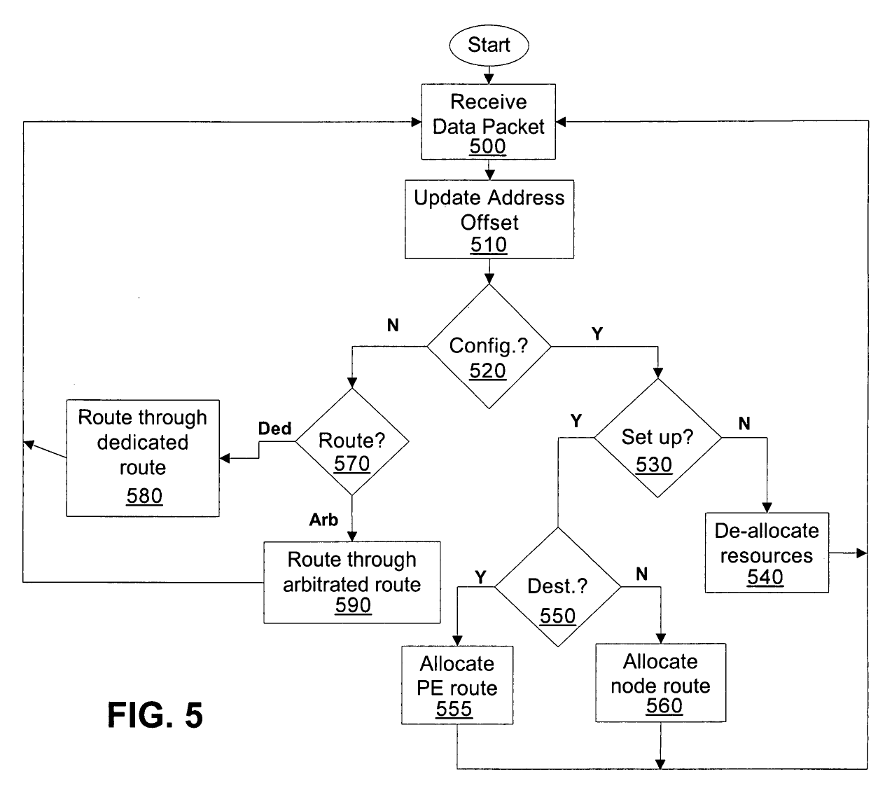

FIG. 5 is a flow chart of an example method to configure a route or route data in accordance with the teachings of the present invention, according to one embodiment. In the illustrated embodiment of FIG. 5, the process begins with block 500 wherein pilot data packet 400 is received by an interconnected-node 6 of multi-node device 200.

Once pilot data packet 400 is received, the process moves to block 510 wherein control logic 242 selectively invokes an instance of configuration manager 245 to update the address offset in bits 0-7 of pilot data packet 400. As mentioned above, in an example embodiment, deltaX is incremented by one if coming from an east nearest neighbor or decremented by one if coming from a west nearest neighbor and deltaY is incremented by one if coming from a south nearest neighbor and decremented by one if coming from a north nearest neighbor, although the invention is not limited in this regard.

Once the address offset is updated, the process moves to block 520 wherein configuration manager 245 reads bit 15 of packet header 420 and determines whether pilot data packet 400 indicates the configuration of a dedicated route through router 240 to route data from a source to a destination.

If bit 15 of pilot data packet 400 indicates the configuration of at least one dedicated route, the process moves to block 530. In block 530, in an example embodiment, configuration manager 245 reads bit 14 of pilot data packet 400 and determines whether at least one dedicated route through router 240 is to be setup or the resources to be released from at least one previously configured dedicated route through router 240.

If bit 14 of pilot data packet 400 indicates the release of at least one configured dedicated route, the process moves to block 540. In block 540, in an example embodiment, configuration manager 245 de-allocates resources of crossbar switch 246 and output port 250, corresponding to at least one previously configured dedicated route, by setting bit 7 of table entry 251 of memory register 248 to indicate a non-configured route, the process then returns to block 500.

If bit 14 of pilot data packet 400 indicates the setup of at least one dedicated route, the process moves to block 550. In block 550, according to an example embodiment, configuration manager 245 reads bits 0-7 of pilot data packet 400 and determines whether the address offset indicates if the node is the destination for data from a source. In an example implementation, if deltaX=0 and deltaY=0 then the node is the destination.

If the address offset indicates that the node is the destination, the process moves to block 555. In block 555, in an example embodiment, configuration manager 245 allocates the resources for a dedicated route through crossbar switch 246 to an output port address corresponding to processing element(s) 260. In this regard, in an example embodiment, configuration manager 245 may populate bit 7 of table entry 251 to indicate a configured dedicated route. In addition, configuration manager 245 will also populate bits 0-3 of table entry 251 with the 4-bit output address corresponding to processing element(s) 260 (i.e. a 4-bit value of 0000). The process then returns to block 500.

If the address offset indicates that the node is not the destination, the process moves to block 560. In block 560, in an example embodiment, configuration manager 245 allocates the resources for at least one dedicated route to another node and/or destination.

According to an example embodiment, configuration manager 245 uses the address offset to determine which route to configure through crossbar switch 246 to at least one output port address 250 to reach the destination. In an example embodiment, the destination may be reached by routing data in a direction that first results in a deltaX=0 and then proceed to route data until deltaY=0, although the invention is not limited in this regard. As mentioned previously, in an interconnected mesh network, deltaX is decremented by 1 if coming from a west nearest neighbor. Thus, for example, if deltaX=1 and deltaY=1 then configuration manager 245 would configure at least one dedicated route through crossbar switch 246 to an output port address 250 corresponding to the east nearest neighbor or node. Accordingly this would result in a deltaX=0 after the address offset is updated by that east nearest neighbor.

In an example implementation, configuration manager 245, based at least in part, on the address offset values in deltaX and deltaY, selectively determines the output address and populate bits 0-3 of table entry 251 with the 4-bit output address corresponding to that output port address (i.e. a 4-bit value of 0001 for the east nearest neighbor). Configuration manager 245 also populates bit 7 of table entry 251 to indicate at least one configured dedicated route through router 240. The process then returns to block 500.

In block 520, in an example embodiment, if pilot data packet 400 does not indicate configuration of at least one dedicated route in bit 15, this may indicate routing pilot data packet 400 and any data associated with pilot data packet 400 through at least one dedicated route of router 240. The process then moves to block 570.

In block 570, according to an example embodiment, control logic 230 selectively invokes an instance of route manager(s) 244 to access memory register 248 and read bit 7 of table entry 251 to determine whether at least one dedicated route through router 240 has been previously configured by configuration manager 245.

If route manager(s) 244 determines that bit 7 of table entry 254 indicates at least one configured dedicated route to route pilot data packet 400 and any data associated with pilot data packet 400 through router 240, the process moves to block 580. In block 580, according to an example embodiment, route manager(s) 244 reads the output port address (i.e. bits 0-3 of table entry 251) and routes pilot data packet 400 and any data associated with pilot data packet 400 through router 240 to the output port corresponding to the 4-bit value in bits 0-3. The process then returns to block 500.

If route manager(s) 244 determines that bit 7 of table entry 251 does not indicate at least one configured dedicated route to route pilot data packet 400 and any data associated with pilot data packet 400 through router 240, the process moves to block 590. In block 590, according to an example embodiment, route manager(s) 244 will arbitrate with all others seeking to route data through router 240 and will allocate route resources to route data packet 400 once a route become available, although the invention is not limited in this regard. Pilot data packet 400 is then routed through crossbar switch 246 and output port address 252. Once pilot data packet 400 and any data associated with pilot data packet 400 is routed, the resources to establish at least one arbitrated route are then de-allocated. The process then returns to block 500.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative of, rather than limiting the scope and coverage of the claims appended hereto.

1. A method comprising:
reading at least a portion of a data packet, the at least portion of a data packet including content to configure at least one dedicated route through at least one node of a plurality of interconnected nodes communicatively coupled by one or more communication links; and
selectively configuring the at least one dedicated route based, at least in part, on the content.

2. A method according to claim 1, wherein the at least portion of a data packet is received by a node containing at least one input port and at least one output port, the at least one input and at least one output port selectively coupled to the one or more communication links.

3. A method according to claim 2, wherein the at least a portion of a data packet includes a packet header.

4. A method according to claim 3, wherein the at least one dedicated route is configured by allocating the resources for at least one dedicated route from a selective input port of the at least one input port to a selective output port of the least one output port and dedicating the resources for the at least one dedicated route.

5. A method according to claim 3, wherein the packet header includes content indicating releasing of allocated resources for at least one dedicated route.

6. A method according to claim 5, wherein the at least one dedicated route is released by de-allocating the resources for the at least one dedicated route from the selective input port of the at least one input to the selective output port of the at least one output port.

7. A method according to claim 1, wherein the plurality of interconnected nodes are communicatively coupled in a mesh network.

8. A method comprising:
reading at least a portion of a data packet, the at least a portion of a data packet including content to indicate at least one dedicated route through at least one node of a plurality of interconnected nodes communicatively coupled by one or more communication links; and
selectively routing data through the at least one dedicated route based, at least in part, on the content.

9. A method according to claim 8, wherein the at least a portion of data packet content indicating the at least one dedicated route is generated by a source transmitting data to a destination.

10. A method according to claim 9, wherein the at least portion of a data packet is received by a node containing at least one input port and at least one output port, the at least one input and at least one output port selectively coupled to the one or more communication links.

11. A method according to claim 10, wherein the at least portion of a data packet includes a packet header.

12. A method according to claim 11, wherein the packet header includes content to indicate routing data through at least one dedicated route, the at least one dedicated route including dedicated resources coupling a selective input port of the at least one input port to a selective output port of the at least one output port, the selective input and output port selectively coupled to the one or more communication links, to route data from the source to the destination

13. A method according to claim 12, wherein data from the source to the destination is routed through the at least one dedicated route.

14. A method according to claim 8, wherein the plurality of interconnected nodes are communicatively coupled in a mesh network.

15. An apparatus comprising:
a node including a router, the node communicatively coupled by one or more communication links to a plurality of interconnected nodes, the router including at least one input port and at least one output port, the at least one input and output port selectively coupled to the one or more communication links; and
a configuration manager within the router, to selectively configure at least one dedicated route from a selective input port of the at least one input port to a selective output port of the at least one output port based, at least in part, on at least a portion of data packet content that indicates a configuration of the at least one dedicated route.

16. An apparatus according to claim 15, wherein the configuration manager selectively configures the at least one dedicated route by allocating the resources to route data from the selective input port to the selective output port and dedicating the allocated resources for the at least one dedicated route.

17. An apparatus according to claim 16, the apparatus further comprising:
a memory to store content, at least a subset of which is executable content; and
a control logic, coupled with the memory, to selectively execute at least a subset of the executable content, to implement an instance of the configuration manager.

18. An apparatus according to claim 17, wherein the control logic is implemented in a network processor.

19. An apparatus comprising:
a node including a router, the node communicatively coupled by one or more communication links to a plurality of interconnected nodes, the router including a memory to store dedicated route information; and
a route manager, within the router, to selectively route data through at least one dedicated route based, at least in part, on the route information stored in the memory.

20. An apparatus according to claim 19, wherein the at least one dedicated route comprises at least one input port coupled to at least one output port, the at least one input and output port selectively coupled to the one or more communication links.

21. An apparatus according to claim 20, wherein the at least one output port includes an output port address corresponding to one or more communication links to the plurality of interconnected nodes, the output port address stored in the memory.

22. An apparatus according to claim 21, wherein the route manager routes data through the at least one dedicated route by reading at least a portion of a data packet, the at least portion of a data packet including content to indicate routing of data through the at least one dedicated route, and routing the data to an output port corresponding to the output port address stored in the memory.

23. An apparatus according to claim 22, the apparatus further comprising:
a memory to store content, at least a subset of which is executable content; and
a control logic, coupled with the memory, to selectively execute at least a subset of the executable content, to implement an instance of the route manager.

24. An apparatus according to claim 23, wherein the control logic is implemented in a network processor.

25. A system comprising:
a plurality of interconnected nodes communicatively coupled by one or more communication links, at least a subset of the plurality of interconnected nodes including a router having a configuration manager to selectively configure at least one dedicated route through the router based, at least in part, on at least a portion of data packet content to indicate the configuration of the at least one dedicated route; and
a substantially omni directional antenna, selectively coupled with at least a subset of the plurality of interconnected nodes to support wireless communications with a remote device.

26. A system according to claim 25, wherein the router contains at least one input port and at least one output port, selectively coupled to the one or more communication links.

27. A system according to claim 26, wherein the configuration manager configures the at least one dedicated route through the router by allocating the resources to route data from a selective input port of the at least one input port to a selective output port of the at least one output port and dedicating the allocated resources for the at least one dedicated route.

28. A system according to claim 27, wherein the router is implemented in a network processor.

29. A system according to claim 25, wherein the plurality of interconnected nodes are communicatively-coupled in a mesh network.

30. A system comprising:
a plurality of interconnected nodes communicatively coupled by one or more communication links, at least a subset of the plurality of interconnected nodes including a router having a memory to store dedicated route information, and a route manager to selectively route data through at least one dedicated route of the router based, at least in part, on the dedicated route information stored in the memory; and
a substantially omni directional antenna, selectively coupled with at least a subset of the plurality of interconnected nodes to support wireless communications with a remote device.

31. A system according to claim 30, wherein the router contains at least one input port and at least one output port, selectively coupled to the one or more communication links.

32. A system according to claim 31, wherein the at least one output port includes an output port address corresponding to at least one communication link to the plurality of interconnected nodes, the output port address stored in the memory.

33. A system according to claim 32, wherein the route manager routes data through the at least one dedicated route by reading at least a portion of a data packet, the at least portion of a data packet including content to indicate the routing of data through at least one dedicated route, and routing the data to an output port corresponding to the output port address stored in the memory.

34. A system according to claim 33, wherein the router is implemented in a network processor.

35. A system according to claim 30, wherein the plurality of interconnected nodes are communicatively coupled in a mesh network.

36. A storage medium comprising content, which, when executed by a machine, causes the machine to:
read at least a portion of a data packet, the at least portion of a data packet including content to configure at least one dedicated route through at least one node of a plurality of interconnected nodes communicatively coupled by one or more communication links; and
selectively configure the at least one dedicated route based, at least in part, on the content, to route data from a source to a destination.

37. A storage medium according to claim 36, wherein the at least portion of a data packet is received by a node containing at least one input port and at least one output port, the at least one input and at least one output port selectively coupled to the one or more communication links.

38. A storage medium according to claim 37, wherein the at least a portion of a data packet includes a packet header.

39. A storage medium according to claim 38, wherein the at least one dedicated route is configured by allocating the resources for at least one dedicated route from a selective input port of the at least one input port to a selective output port of the at least one output port and dedicating the resources for the at least one dedicated route.

40. A storage medium according to claim 37, wherein the packet header includes content indicating releasing of allocated resources for at least one dedicated route.

41. A storage medium comprising content, which, when executed by a machine, causes the machine to:
read at least a portion of a data packet, the at least a portion of a data packet including content to indicate at least one dedicated route through at least one node of a plurality of interconnected nodes communicatively coupled by one or more communication links; and
selectively route data through the at least one dedicated route based, at least in part, on the content.

42. A storage medium according to claim 41, wherein the at least a portion of data packet content indicating the at least one dedicated route is generated by a source transmitting data to a destination.

43. A storage medium according to claim 42, wherein the at least portion of a data packet is received by a node, the node containing at least one input port and at least one output port, the at least one input and at least one output port selectively coupled to the one or more communication links.

44. A storage medium according to claim 43, wherein the at least portion of a data packet includes a packet header.

45. A storage medium according to claim 46, wherein the packet header includes content to indicate routing data through at least one dedicated route, the dedicated route including dedicated resources coupling a selective input port of the at least one input port to a selective output port of the at least one output port, the selective input and output port selectively coupled to the one or more communication links, to route data from the source to the destination.

46. A storage medium according to claim 45, wherein data from the source to the destination is routed through the dedicated route.
